(19) United States
(12) Patent Application Publication
(10) Pub. No.: US 2017/0069190 A1
(43) Pub. Date: Mar. 9, 2017

(54) SYSTEM AND METHOD FOR DETECTING AND RESPONDING TO A THREAT IN OR AROUND A FACILITY

(71) Applicants: Gregory W. Hansen, Olney, MD (US); Yakov Shadevich, Clarksburg, MD (US)

(72) Inventors: Gregory W. Hansen, Olney, MD (US); Yakov Shadevich, Clarksburg, MD (US)

(73) Assignee: MELE Associates, Inc..

(21) Appl. No.: 15/185,333

(22) Filed: Jun. 17, 2016

Related U.S. Application Data
(60) Provisional application No. 62/181,808, filed on Jun. 19, 2015.

(51) Int. Cl. G08B 21/02; G08B 27/00; G08B 13/196; G08B 13/08

(52) U.S. Cl. CPC G08B 21/02; G08B 13/08; G08B 27/001; G08B 13/196

(57) ABSTRACT

A system for detecting and mitigating a threat in or around a facility is disclosed. In one embodiment, the system comprises a sensor or receiver configured to detect a biometric marker, such as an iris scan, fingerprint, voice pattern, or facial pattern, and comparing those markers to a database of biometric markers to determine if a match exists. Alternatively, or additionally, the system is configured to detect an anomaly in the background environment of the facility by measuring a variety of variables, such as temperature, pressure, noise-levels, radiation levels, densities, and magnetic fields, and comparing those variables to predetermined threshold values to determine if an anomaly exists. If a match with the biometric marker exists, or if an anomaly in the environmental background exists, the system sends a notification to alert and secure the facility, and contact first responders. A computer-implemented method for securing a facility from a threat using the foregoing system is also described.

This application claims priority to U.S. Provisional Application No. 62/181,808, filed on Jun. 19, 2015, which is incorporated herein by reference in its entirety.

### TECHNICAL FIELD

The present disclosure generally relates to systems for detecting a threat in or around a facility. The present disclosure also relates to methods of protecting a facility and occupants located in or around it from a threat using the disclosed system.

### BACKGROUND

Despite the increase in domestic terrorism, and the regular occurrence of mass shootings and similar tragedies in public facilities, such as schools, theaters, shopping malls, courthouses, and other publicly accessible facilities, most building today are protected by passive alarm systems. These systems comprise sensors connected to a telephone dialer that are designed to be monitored with a telephone response to a police or fire department. Such systems are not typically intended to protect the occupants of the facility. Rather, they are primarily intended to protect an unoccupied building. To the extent that such a building is occupied, typical alarm systems include an audible warning device that alerts occupants to evacuate the building.

The types of alarms in use today are limited in many respects. For example, they typically do not provide assistance to responding personnel, including monitoring the real-time progress of events or assisting first responders how to best handle the threat. They also do not isolate a threat by locking down various parts of the facility, which could allow the threat to go unimpeded with the entire facility being at risk until first responders arrive. Perhaps most importantly, the typical alarm and security systems that protect a majority of buildings today simply react to a limited number of threats, while not proactively (or intelligently) preventing an attack.

Accordingly, there is a need for a system that detects a threat in or around a facility before a tragedy occurs, such as by actively monitoring people entering and the environment around a facility. If a threat is detected, there is a need for a system that proactively manages the threat, such as by providing assistance to responding personnel, and by isolating the threat by locking down various parts of the facility.

### SUMMARY

In view if the foregoing there is disclosed a system for detecting a threat in or around a facility. In one embodiment, the system comprises at least one sensor or receiver that is configured to detect a biometric marker or an anomaly in the background environment of the facility. The system also comprises at least one data integration device configured to accept, process, and compare the processed data generated from the at least one sensor or receiver, to stored biometric markers to determine if a match exists. The data integration device is further configured to compare the data generated from the at least one sensor or receiver to predetermined threshold values of the environment to determine if an anomaly exists, or to both stored biometric markers and threshold values. The system further comprises at least one processor configured to send a notification if a match with the biometric marker exists, or if an anomaly in the environmental background exists, wherein the notification is sent, by the at least one processor, to at least one actuator for triggering door and/or window locks located in or around the facility. The notification can also be sent to one or more electronic devices, one or more law enforcement agencies, or any combination of the foregoing.

In another embodiment, a method for securing a facility from a threat is disclosed. The method comprises detecting a biometric marker or measuring the environment in or around a facility with at least one sensor or receiver, processing data generated from the at least one sensor or receiver with a processor, and comparing the processed data received from the sensor or receiver. The method compares the data received from the sensor or receiver to stored biometric markers to determine if a match exits. The method further compares the data generated from the at least one sensor or receiver to predetermined threshold values of the environment to determine if an anomaly exists, or to both stored biometric markers and the threshold values. The method further comprises sending a notification if a match in biometric markers or an anomaly in the environment is determined, wherein the notification is sent, by the at least one processor, to at least one actuator for triggering door and/or window locks located in or around the facility. The notification can also be sent to one or more electronic devices, to one or more law enforcement agencies, or any combination of the foregoing.

It is to be understood that both the foregoing general description and the following detailed description are exemplary and explanatory only and are not restrictive of the invention, as claimed.

### BRIEF DESCRIPTION OF THE DRAWING

The accompanying figure, which are incorporated in and constitute a part of this specification, illustrate several embodiments of the invention and together with the description, serve to explain the principles of the invention.

FIG. 1 is a wire diagram of an emergency lockdown system for detecting an active shooter in a school according to the present disclosure.

FIG. 2 is a high level block diagram of an emergency lockdown system according to the present disclosure.

### DETAILED DESCRIPTION

The inventive system generally comprises a customized printed circuit board (PCB) with at least the following functions:
Provide circuitry for power generation and distribution to various components and subassemblies.
Provide circuitry for backup battery charging and UPS power source switching.
Provide Terminal blocks and connectors to interface various components and subassemblies.
Provide connector interfaces for a Beaglebone Single Board computer and Beaglebone expansion capes.
Provide mechanical support and housing for various subassemblies, such as USB hub modules.
Provide any miscellaneous supporting circuitry to facilitate hardware interfaces, including but not limited to buffers, voltage level translators, protection, Fuses, switches, buttons, etc.

In one embodiment, the Beaglebone single board Linux computer will be the main processing unit of the inventive system. Its main functions, implemented as Linux embedded software, will include:
Provide a wired TCP/IP link to the Gunshot Detector.
Provide ability to configure the device, and listen to Messages received from the device in pseudo-real time. Interpret the messages and perform corresponding function if/when a particular alert is received.
Provide an interface to an outside world via a wired Ethernet or a WiFi wireless connection to the Internet. Be able to transmit SOH information, and real time, or pseudo-real time alerts to multiple remote servers.
Provide ability to interface to a wireless relay control module (e.g. XBee) in order to wirelessly control door locks and alarms.
Provide ability to monitor several inputs, and toggle several outputs in response to system events. This includes the ability to enable an alarm or a siren at a push of a button.
Provide an ability to configure the system logic, and event triggered responses through an easy to use User Interface

The following is a description of some of the components that can be used in the disclosed system.

Wireless Transceiver

The disclosed PCB may contain a socket for the off the shelf wireless modules made by Digi International® Inc., for example. The modules offer a simple UART front end interface, and a selection of wireless RF backend interfaces such as 802.15.4, ZigBee, WiFi or Bluetooth. The modules are interchangeable and footprint compatible, and therefore any wireless interface can be used depending on particular site or system needs with minor software updates.

USB Hub

In order to facilitate system expansion, the single USB port of the beaglebone computer can be fanned out to 4 system USB ports. This will be achieved via an off the shelf USB Hub OEM module such as B&B Electronics OEM USB Hub. Alternatively, any COTS USB hub can be used as an external add-on module.

WiFi Adapter

Since the Beaglebone is a full featured Linux computer, any COTS USB WiFi adapter with Linux drivers can be used to connect the Beaglebone to the WiFi network. For example UWN100 from Logicsupply Inc. In one embodiment, a BeagleBone black was tested and proven to be compatible.

Ethernet Switch

In one embodiment, the disclosed system uses multiple wired 10/100 Ethernet peripherals to interface to the Beaglebone computer. In order to accommodate this, an external 4-port Ethernet switch can be used. In addition, to simplify the system and interface to the BBN Gunshot detector, a PoE (Power Over Ethernet) compatible Ethernet Switch such as POE400 by Planet Networking, is used.

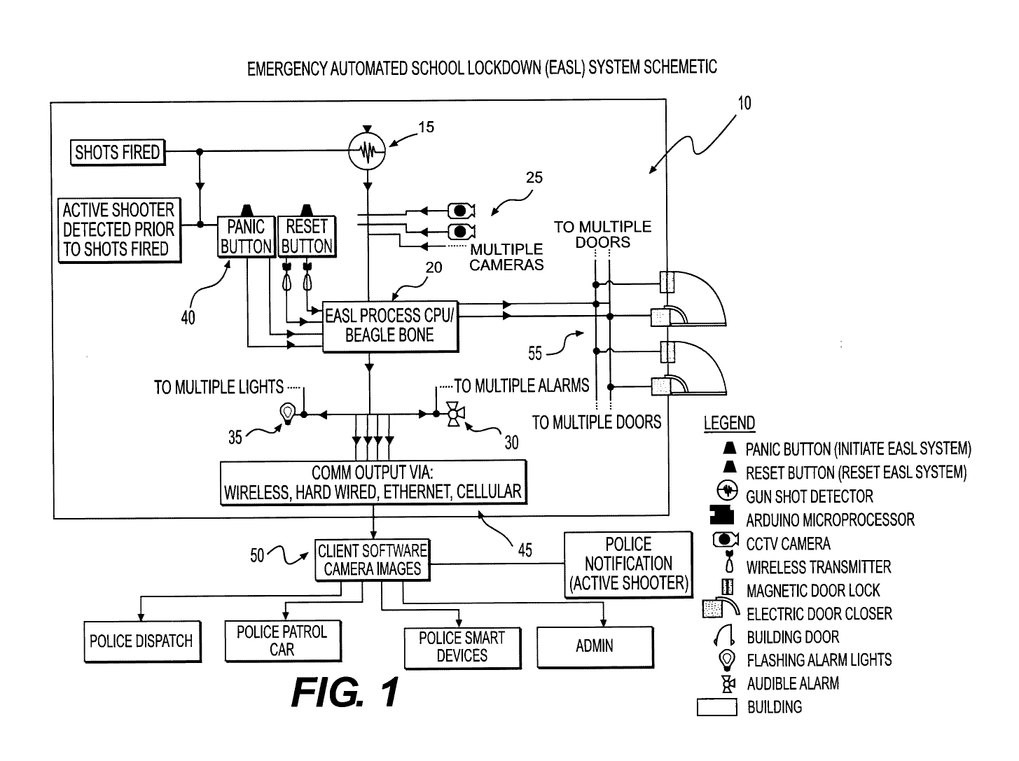

Referring now to the FIG. 1, which depicts in wire diagram form the operation of the active shooter, emergency lockdown system 10 according to one embodiment of the present disclosure.

In FIG. 1, the device features at least one detector unit 15 mounted in a structure in a location remote to a central monitoring unit 20. Each detector unit 15 installed would be powered by conventional power means such as a battery or AC power or a combination thereof which would protect the system from power outages. In one embodiment, the system described herein receives 120V AC from an electrical service panel. The AC voltage can be converted to 14V DC, and further down converted to 12V, 5V and 3.3V as well as any other voltages required by the electronics. The described system may also contain a sealed lead acid battery to provide up to 20 minutes of uninterrupted system operation in case of main power loss. The PCB electronics are configured to manage dual power inputs and seamlessly switch in case of the main input dropping out and supplying power from the Backup Battery.

The device 10 features a means to detect a firearm sound discharge from the decibel level and duration of the sonic wave generated by the firearm which is located inside each detector unit 15. To support a desired feature of the system, the system should interface to a Gunshot Detection System. One non-limiting example of a gunshot detection system that can be used is the Raytheon® BBN Indoor system. This unit interfaces to a host computer via a simple message based TCP/IP protocol over wired Ethernet. It is powered by a POE injector or POE compatible Ethernet Switch. Other firearm discharge detection devices and alarm systems that can be used in the disclosed system are found in U.S. Pat. Nos. 6,552,963 and 8,809,787; and U.S. Published Application No. 2015/0070166, which are herein incorporated by reference.

The shot detector sensor located in each device measures a variety of variables, including the decibel level and time span of the sonic waves in order to determine location of the active shooter. Systems and methods of determining source and location of an event, such as a gunshot or an explosion, is described in U.S. Pat. No. 8,369,184, which is herein incorporated by reference.

This information is communicated to the central monitoring unit 20, and is used to determine the exact location of the tripped detector sending the signal, from a stored address associated with the particular detector unit 15. In one embodiment, the system includes one or more cameras 25 to provide visual surveillance of the threat, which would assist first responders in accessing the status of the threat in real time.

Receipt of the signal from a tripped detector unit 15 alerts the central monitoring unit 20 that the individual tripped detector unit 15 has detected a threat in its proximity. While FIG. 1 specifically refer to the detection of gun shots, the detector 15 could be used to detect any of the threats described herein, For example, if the detector is used to monitor radiation levels or temperature, any level of radiation or temperature above a threshold level could trip the detector. Regardless of the detector used or the specific threat detected, the tripped detector 15 could initiate an audible alarm means 30 and/or visible alarm means 35 of the tripped detector unit 15. In one embodiment, the audible warning can be either a noise such as a beeper or buzzer, and/or a recorded voice message warning occupants of the exact nature of the threat, and how to respond to that threat. For example, an audio alarm can instruct occupants to remain in a locked room (if an active shooter has been detected), or how to exit the building (if fire, chemical or other toxic threats have been detected). Computer enabled emergency notification systems are described in U.S. Pat. Nos. 7,277,018 and 7,460,020, which are herein incorporated by reference.

Optionally, the system comprises a manual means for an individual to activate the system, such as by a panic button 40. The central processing unit 20, like each detector unit 15, would also be powered by conventional power means such as a battery or AC power or a combination thereof which would protect the system from power outages.

With the signal of a threat being received, such as a firearm discharge being received, the central monitoring unit 20 will then communicate with relevant personnel, such as occupants in the monitored facility and first responders 50 via various means, such as wireless communication and cellular communication 45. The system will also automatically activate window and door locks around the tripped detector 55 in order to isolate the threat from the unaffected parts of the facility.

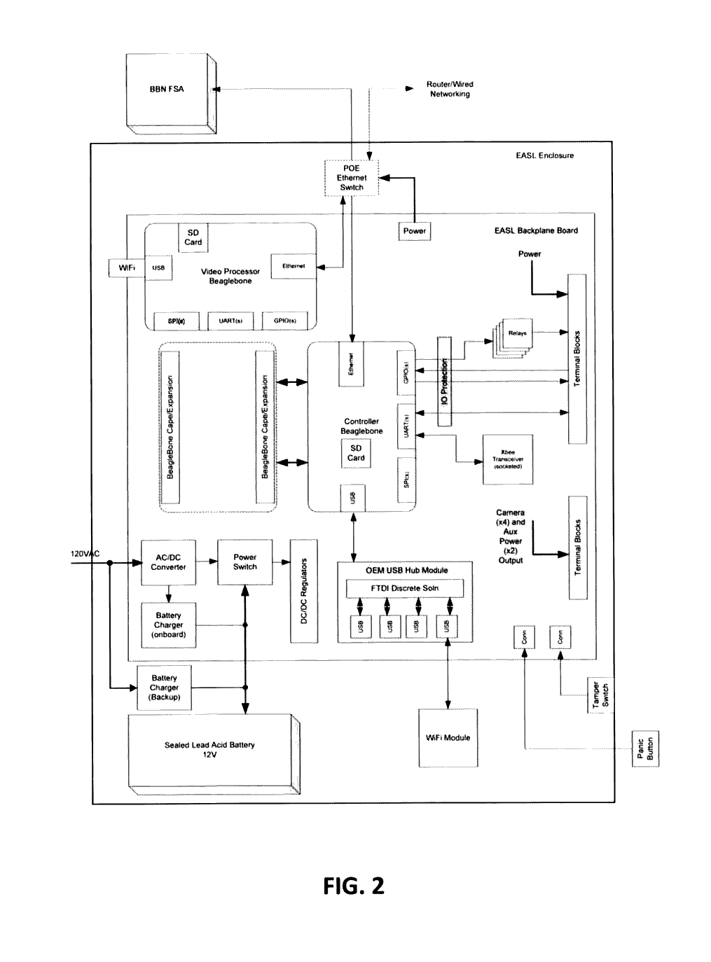

With regard to FIG. 2, there is provided a high level block diagram of a system according to the present disclosure. FIG. 2 shows a video processor; however, a video processor is not required in the disclosed system. Rather, in an embodiment, the system can comprise cameras that do not need to have any additional processing.

In one embodiment, there is provided a system for detecting a threat in or around a facility. The system comprises at least one sensor or receiver that is configured to detect a biometric marker or an anomaly in the background environment of the facility. Systems and method for biometric authentication through layering biometric traits are found in U.S. Pat. No. 7,536,557, which is herein incorporated by reference. Adaptive multi-modal integrated biometric identification detection and surveillance systems are found in U.S. Pat. No. 7,956,890, which is herein incorporated by reference.

The system also comprises at least one data integration device configured to accept, process, and compare data generated from the at least one sensor or receiver, to stored biometric markers to determine if a match exists. The data integration device is further configured to compare the data generated from the at least one sensor or receiver, to predetermined threshold values of the environment to determine if an anomaly exists, or to both stored biometric markers and the threshold values. The system further comprises at least one processor configured to send a notification if a match with the biometric marker exists, or if an anomaly in the environmental background exists, wherein the notification is sent, by the at least one processor, to at least one actuator for triggering door and/or window locks located in or around the facility. The notification can also be sent to one or more electronic devices, one or more law enforcement agencies, or any combination of the foregoing. The electronic devices can be cell phones, computers, PDAs, pagers, or combinations thereof. The system can further comprise a panic button for generating the notification, such as manually by an individual who detects a threat.

In one embodiment, the at least one sensor or receiver transmits a status message to the data integration device. The status message can determine if: the at least one sensor or receiver is on or off, the circuits in the at least one sensor or receiver are functioning correctly, the at least one sensor or receiver is connected to the data integration device, the at least one sensor or receiver is responding to periodic testing procedures, the at least one sensors' or receivers' hardware, software, and/or enclosure has been tampered with or compromised.

The notification sent to the one or more electronic devices or agencies include authenticated data, comprising one or more parameters including the detection of a gunshot, when the gunshot was fired, images of the area where the gunshot originated, and status of the doors and/or window locks. The one or more electronic devices can contain instructions configuring the one or more electronic devices to activate an alarm in response to one or more of the parameters in the authenticated data.

The biometric marker in the system can be chosen from an iris scan, retina scan, fingerprint, palm print, voice pattern, or facial pattern. The environmental background can be chosen from the temperature, pressure, noise-level, radiation levels, density of an object, or magnetic field. The system can also comprise a device for detecting a weapon by measuring the changes in density and/or magnetic field associated with a potential adversarial threat. The detection device that preemptively identifies a weapon associated with the potential adversarial threat can send an alarm signal to the data integration device.

In one embodiment, the system comprises a hazardous particle detection device that measures the concentration of hazardous gas particles and/or hazardous radiation particles. The hazardous particle detection device can send an alarm signal to the data integration device if hazardous gas particles and/or hazardous radiation particles are detected. The sensors or receivers in the system can be configured to measure temperature, and an anomaly comprising a rate of change in temperature in degrees Fahrenheit or Celsius per unit of time, or a constant temperature above a certain number of degrees Fahrenheit or Celsius.

In one embodiment, the sensors or receivers can also be configured to measure air pressure, acoustic waves, optical flashes, shockwaves, or combinations thereof from an exploding device. The exploding device can be a firearm or a bomb. The system can further comprise software that determines if the exploding device is a firearm, and the caliber of the bullet discharged from the firearm by analyzing the energy signature of the energy produced by the exploding device after the bullet is discharged from the firearm. The sensors or receivers can also be configured to measure the time of arrival, an angle-of-arrival, particle velocity, or combinations thereof of the pressure, acoustic waves, optical flashes, shockwaves, or combinations thereof. The measure of the time of arrival, angle-of-arrival, particle velocity, or combinations thereof are based on location of the at least one receiver sending data to the processor. The location of the at least one receiver can be determined using measurements made from a global positioning system (GPS) or other satellite-based navigation system.

The system can also comprise at least one audio device, and/or video device for directing members in the facility to a secured location if a threat is detected. The video devices can be configured to generate video data corresponding to the threat, integrate the video data with data corresponding to the threat detected by the at least one sensor, and transmit the video data to the one or more law enforcement agencies and/or one or more non-law enforcement users. In some embodiments the video devices can be analog or digital cameras, in other embodiments the video devices can be a combination of analog and digital devices. The cameras should be OpenCV or FFMpeg compliant.

The system can further comprise software that analyzes the video data to identify a full complement of the event data, including irregular human actions by the threat, and possession of a weapon by the threat.

In another embodiment, a method for securing a facility from a threat is provided. The method comprises detecting a biometric marker or measuring the environment in or around a facility with at least one sensor or receiver, processing data generated from the at least one sensor or receiver with a processor, and comparing the processed data received from the sensor or receiver to stored biometric markers to determine if a match exits. The method can further compare the data received from the sensor or receiver to predetermined threshold values of the environment to determine if an anomaly exists, or the stored biometric markers and threshold values. The method further comprises sending a notification if a match in biometric markers or an anomaly in the environment is determined. In some embodiments the method further includes sending the notification to at least one actuator for triggering door and/or window locks located in or around the facility, to one or more electronic devices, to one or more law enforcement agencies, or any combination of the foregoing.

The biometric marker can be chosen from an iris scan, retina scan, fingerprint, palm print, voice pattern, and facial pattern. The environmental background can be determined by baseline temperatures, pressures, noise-levels, radiation levels, object densities, and magnetic fields of the environment or objects in the environment.

The notification sent to the one or more electronic devices or agencies can include authenticated data, comprising one or more parameters including: when shots were fired, images of the area where the shots originated, and status of the doors and/or window locks. The one or more electronic devices can contain instructions configuring the one or more electronic devices to activate an alarm in response to the one or more of the parameters in the authenticated data.

The method can measure the temperature and an anomaly comprising a rate of change in temperature in degrees Fahrenheit or Celsius per unit of time, or a constant temperature above a certain number of degrees Fahrenheit or Celsius, using the sensors or receivers. The method can measure the air pressure, acoustic waves, optical flashes, shockwaves, or combinations thereof from an exploding device using the at least one sensor or receiver. The exploding device can be a firearm or a bomb. The method further comprises determining if the exploding device is a firearm, and the caliber of the bullet discharged from the firearm, by analyzing the energy signature of the energy produced by the exploding device after the bullet is discharged from the firearm. The method can measure the time of arrival, angle-of-arrival, particle velocity, or combinations thereof of the pressure, acoustic waves, optical flashes, shockwaves, or combinations thereof using the sensors or receivers. The method further comprises determining the location of the at least one receiver by processing measurements made from a global positioning system (GPS) or other satellite-based navigation system.

In one embodiment, the method further comprises measuring the concentration of hazardous gas particles and/or hazardous radiation particles using a hazardous particle detection device. The method further comprises sending an alarm signal to the data integration device if hazardous gas particles and/or hazardous radiation particles are detected by the hazardous particle detection device.

In another embodiment, the method comprises detecting a weapon by measuring changes in density and/or magnetic field associated with a potential adversarial threat using a weapon detection device. The method further comprises preemptively identifying a weapon on the potential adversarial threat, and sending an alarm signal to the data integration device using a hazardous particle detection device.

Regardless of the threat detected, the method further comprises directing members in the facility to a secured location if the threat is detected using at least one audio device, and/or video device, wherein the audio and/or video device is configured to generate video data corresponding to the threat, integrate the video data with data corresponding to the threat detected by the at least one sensor or receiver, and transmit the video data to the one or more law enforcement agencies and/or one or more non-law enforcement users.

The Camera Interface that can be used in the disclosed system is a Beaglebone Computer 2. In an embodiment, the disclosed system can power up to four (4) IP (Internet) Cameras up to 30 meters away. Other than receiving power, the cameras will be self-sufficient and configured independently using their own software.

A dedicated Beaglebone or an alternative Video Processor Card (in case of future feature expansion requirements) as well as ViewCommander software will “tap” into the IP video feed and perform necessary actions (i.e. capture and store still frames). The disclosed System will transmit messages to the ViewCommander server via HTTP POST protocol.

The method further comprises analyzing the video data to identify a full complement of the event data, including irregular human actions by the threat and possession of a weapon by the threat.

The method further comprises transmitting a status message to the data integration deice from the at least one sensor or receiver. The status message can determine if the one or more electronic devices are on or off, the circuits in the one or more electronic devices are functioning correctly, the one or more electronic devices are connected to the data integration device, the one or more electronic devices are responding to periodic testing procedures, the one or more electronic devices' hardware, software, and/or enclosure has been tampered with or compromised.

In an embodiment, a simple web based GUI will be implemented in order to configure the disclosed system. An Administrator would need to physically connect to the Ethernet port on the inventive system, and log into a corresponding TCP/IP port. The Beaglebone will respond with a password protected prompt and upon successful login, allow for the Administrator to configure system rules and behavior.

Expansion and External Interfaces

One feature of the disclosed system is the ability to interface to external component and allow for expanded suite of sensors to be integrated at a later time. To accommodate this flexibility, a large number of Beaglebone GPIOs as well as all standard communication interfaces, including UARTs, I2C, SPI, USB and Ethernet, will be routed out to expansion headers as well as Terminal Blocks. These IOs will be protected via buffers from ESD and external hardware power glitches. Expanded functionality will be achieved using daughter cards or cables to attach new sensors to the inventive system. A few of the GPIO will drive on-board relays to allow switching of high-current or AC sources.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term and/or includes any and all combinations of one or more of the associated listed items.

The description of the embodiments herein had been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for detecting a threat in or around a facility, the system comprising:
at least one sensor or receiver configured to detect the following:
a biometric marker; or
an anomaly in the background environment of the facility,
at least one data integration device configured to accept and process data generated from the at least one sensor or receiver, wherein the data integration device compares the processed data received from said sensor or receiver:
to stored biometric markers to determine if a match exists;
to predetermined threshold values of the environment to determine if an anomaly exists; or
to both stored biometric markers and threshold values;
at least one processor configured to send a notification if a match with the biometric marker exists, or if an anomaly in the environmental background exists, wherein the notification sent by the at least one processor is sent:
to at least one actuator for triggering door and/or window locks located in or around the facility;
to one or more electronic devices;
to one or more law enforcement agencies; or
to combinations of the foregoing.

2. The system of claim 1, wherein the biometric marker is chosen from an iris scan, retina scan, fingerprint, palm print, voice pattern, and facial pattern.

3. The system of claim 1, wherein the environmental background is chosen from the temperature, pressure, noise-level, radiation levels, density of an object, and magnetic field.

4. The system of claim 3, further comprising a device for detecting a weapon by measuring changes in density and/or magnetic field associated with a potential adversarial threat.

5. The system of claim 4, wherein the detection device that preemptively identifies a weapon associated with the potential adversarial threat sends an alarm signal to the data integration device.

6. The system of claim 3, further comprising a hazardous particle detection device that measures the concentration of hazardous gas particles and/or hazardous radiation particles.

7. The system of claim 6, wherein the hazardous particle detection device sends an alarm signal to the data integration device if hazardous gas particles and/or hazardous radiation particles are detected.

8. The system of claim 1, wherein the sensors or receivers are configured to measure the rate of change in temperature, and an anomaly comprising a rate of change in temperature per unit of time, or a constant temperature above a certain temperature value.

9. The system of claim 1, wherein the sensors or receivers are configured to measure air pressure, acoustic waves, optical flashes, shockwaves, or combinations thereof from an exploding device.

10. The system of claim 9, wherein the exploding device is a firearm or a bomb.

11. The system of claim 10, further comprising software that determines if the exploding device is a firearm, and the caliber of the bullet discharged from the firearm by analyzing the energy signature of the energy produced by the exploding device after the bullet is discharged from the firearm.

12. The system of claim 9, wherein the sensors or receivers are configured to measure a time of arrival, an angle-of-arrival, particle velocity, or combinations thereof of the pressure, acoustic waves, optical flashes, shockwaves, or combinations thereof.

13. The system of claim 12, wherein the measure of the time of arrival, angle-of-arrival, particle velocity, or combinations thereof are based on location of the at least one receiver sending data to the processor.

14. The system of claim 13, wherein the location of the at least one receiver is determined using measurements made from a global positioning system (GPS) or other satellite-based navigation system.

15. The system of claim 1, further comprising at least one audio device, and/or video device for directing members in the facility to a secured location if a threat is detected, wherein the video device is configured to:
generate video data corresponding to the threat;
integrate the video data with data corresponding to the threat detected by the at least one sensor; and
transmit the video data to the one or more law enforcement agencies and/or one or more non-law enforcement users.

16. The system of claim 15, wherein the at least one video device is an analog camera or digital camera.

17. The system of claim 15, further comprising software that analyzes the video data to identify a full complement of the event data, including irregular human actions by the threat; and possession of a weapon by the threat.

18. The system of claim 1, wherein said one or more electronic devices comprises a cell phone, computer, PDA, pager, or combinations thereof.

19. The system of claim 1, further comprising a panic button for generating the notification.

20. The system of claim 1, wherein the at least one sensor or receiver transmits a status message to the data integration device.

21. The system of claim 20, wherein the status message determines if: the at least one sensor or receiver is on or off, the circuits in the at least one sensor or receiver are functioning correctly, the at least one sensor or receiver is connected to the data integration device, the at least one sensor or receiver is responding to periodic testing procedures, the at least one sensors' or receivers' hardware, software, and/or enclosure has been tampered with or compromised.

22. The system of claim 1 wherein the notification sent to the one or more electronic devices or agencies include authenticated data, comprising one or more parameters including the detection of a gunshot, when said gunshot was fired, images of the area where the gunshot originated, and status of the doors and/or window locks.

23. The system of claim 22, wherein the one or more electronic devices contain instructions configuring the one or more electronic devices to activate an alarm in response to one or more of the parameters in the authenticated data.

24. A computer-implemented method for securing a facility from a threat, the method comprising:
detecting a biometric marker or measuring the environment in or around a facility with at least one sensor or receiver;
processing data generated from the at least one sensor or receiver with a processor;
comparing the processed data received from said sensor or receiver:
to stored biometric markers to determine if a match exists;
to predetermined threshold values of the environment to determine if an anomaly exists; or
to both stored biometric markers and threshold values;
sending a notification if a match in biometric markers or an anomaly in the environment is determined, wherein the notification is sent:
to at least one actuator for triggering door and/or window locks located in or around the facility;
to one or more electronic devices;
to one or more law enforcement agencies; or
to combinations of the foregoing.

25. The method of claim 24, wherein the biometric marker is chosen from an iris scan, retina scan, fingerprint, palm print, voice pattern, and facial pattern.

26. The method of claim 24, wherein the environmental background is determined by baseline temperatures, pressures, noise-levels, radiation levels, object densities, and magnetic fields of the environment or objects in the environment.

27. The method of claim 26, further comprising detecting a weapon by measuring changes in density and/or magnetic field associated with a potential adversarial threat using a weapon detection device.

28. The method of claim 27, further comprising preemptively identifying a weapon on the potential adversarial threat, and sending an alarm signal to the data integration device using a hazardous particle detection device.

29. The method of claim 26, further comprising measuring the concentration of hazardous gas particles and/or hazardous radiation particles using a hazardous particle detection device.

30. The method of claim 29, further comprising sending an alarm signal to the data integration device if hazardous gas particles and/or hazardous radiation particles are detected by the hazardous particle detection device.

31. The method of claim 24, further comprising measuring the temperature and an anomaly comprising a rate of change in temperature in degrees Fahrenheit or Celsius per unit of time, or a constant temperature above a certain number of degrees Fahrenheit or Celsius, using the sensors or receivers.

32. The method of claim 24, further comprising measuring the air pressure, acoustic waves, optical flashes, shockwaves, or combinations thereof from an exploding device using the at least one sensor or receiver.

33. The method of claim 32, wherein the exploding device is a firearm or a bomb.

34. The method of claim 32, further comprising measuring the time of arrival, angle-of-arrival, particle velocity, or combinations thereof of the pressure, acoustic waves, optical flashes, shockwaves, or combinations thereof using the sensors or receivers.

35. The method of claim 34, further comprising determining the location of the at least one receiver by processing measurements made from a global positioning system (GPS) or other satellite-based navigation system.

36. The method of claim 24, further comprising directing members in the facility to a secured location if the threat is detected using at least one audio device, and/or video device, wherein the audio and/or video device is configured to:
generate video data corresponding to the threat;
integrate the video data with data corresponding to the threat detected by the at least one sensor or receiver; and
transmit the video data to the one or more law enforcement agencies and/or one or more non-law enforcement users.

37. The method of claim 36, further comprising analyzing the video data to identify a full complement of the event data, including: irregular human actions by the threat; and possession of a weapon by the threat.

38. The method of claim 33, further comprising determining: if the exploding device is a firearm, and the caliber of the bullet discharged from the firearm, by analyzing the energy signature of the energy produced by the exploding device after the bullet is discharged from the firearm.

39. The method of claim 24, further comprising transmitting a status message to the data integration device from the at least one sensor or receiver.

40. The method of claim 39, wherein the status message determines if the one or more electronic devices are on or off, the circuits in the one or more electronic devices are functioning correctly, the one or more electronic devices are connected to the data integration device, the one or more electronic devices are responding to periodic testing procedures, the one or more electronic devices' hardware, software, and or/enclosure has been tampered with or compromised.

41. The method of claim 24, wherein the notification sent to the one or more electronic devices or agencies include authenticated data, comprising one or more parameters including: when shots were fired, images of the area where the shots originated, and status of the doors and/or window locks.

42. The method of claim 41, wherein the one or more electronic devices contain instructions configuring the one or more electronic devices to activate an alarm in response to the one or more of the parameters in the authenticated data.
